(19) United States
(12) Patent Application Publication
(10) Pub. No.: US 2004/0099105 A1
(43) Pub. Date: May 27, 2004

(54) SCREW BIT REPLACING DEVICE

(76) Inventors: Chun-Chih Lai, Taichung City (TW); Shin-Nan Chang, Taichung City (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/306,552

(22) Filed: Nov. 26, 2002

(51) Int. Cl. B25B 23/06

(52) U.S. Cl. 81/434

(57) ABSTRACT

A screw bit replacing device for screw dispensers includes a main body having a passage defined therethrough in which a shaft is rotatably received. The shaft has a threaded recess defined in an end thereof so as to be engaged with a screw bit. A barrel has a tubular portion inserted in the passage and series of screws are sent in the barrel. A slot is defined through a wall of the tubular portion of the barrel and a plate is removably inserted in the slot. The plate has at least one aperture defined therethrough which is engaged with the screw bit so that when rotating the shaft, the screw bit is easily to be connected to or disengaged from the shaft.

### FIELD OF THE INVENTION

The present invention relates to a screw bit replacing device that includes a plate inserted in the screw dispenser and holding the screw bit such that the driving shaft is easily disengaged from the screw bit.

### BACKGROUND OF THE INVENTION

A conventional screw dispenser generally includes series of screws which are sent into the screw dispenser and a shaft which is connected with a screw bit which is engage with the screw head. When the shaft is rotated, the screws penetrate into object by the screw bit. The type of the screw bit has to be fit with the slots in the screw head so as to efficiently rotate the screws into the objects. The screw bit has to be changed if the screws to be used have a head that is different from type of screw bit. An inherent shortcoming of the conventional screw dispenser has to disengage many parts when replacing the screw bits and the process for replacing the screw bits takes a lot of time.

The present invention intends to provide a screw bit replacing device that is easily to connect a screw bit to the shaft.

### SUMMARY OF THE INVENTION

In accordance with one aspect of the present invention, there is provided a screw bit replacing device for screw dispensers and the device comprises a main body having a passage and a shaft is rotatably received in the passage. The shaft has a threaded recess defined in an end thereof so as to be connected to a screw bit. A barrel has a tubular portion inserted in the passage and is connected to series of screws. A slot is defined through a wall of the tubular portion of the barrel and a plate is inserted in the slot. The plate has an aperture which is engaged with the function end of the screw bit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the screw bit replacing device of the present invention;

FIG. 2 is a perspective view to show one side of the screw dispenser of the present invention;

FIG. 3 is a perspective view to show the other side of the screw dispenser of the present invention, and

FIG. 4 shows the plate is inserted in the barrel to engage the screw bit in the barrel.

### DETAILED DESCRIPTION OF THE PREFERRED EMBODIMENT

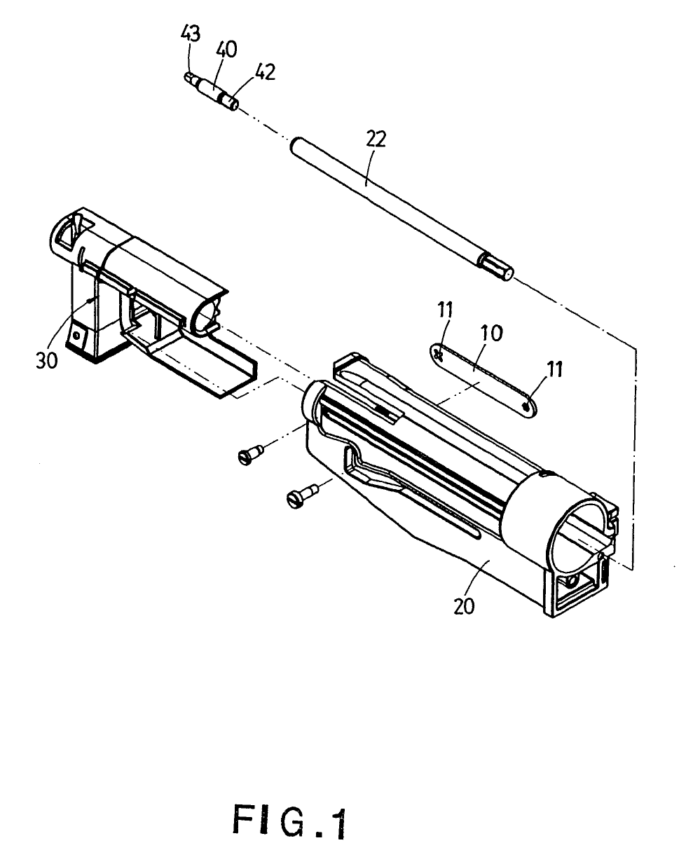

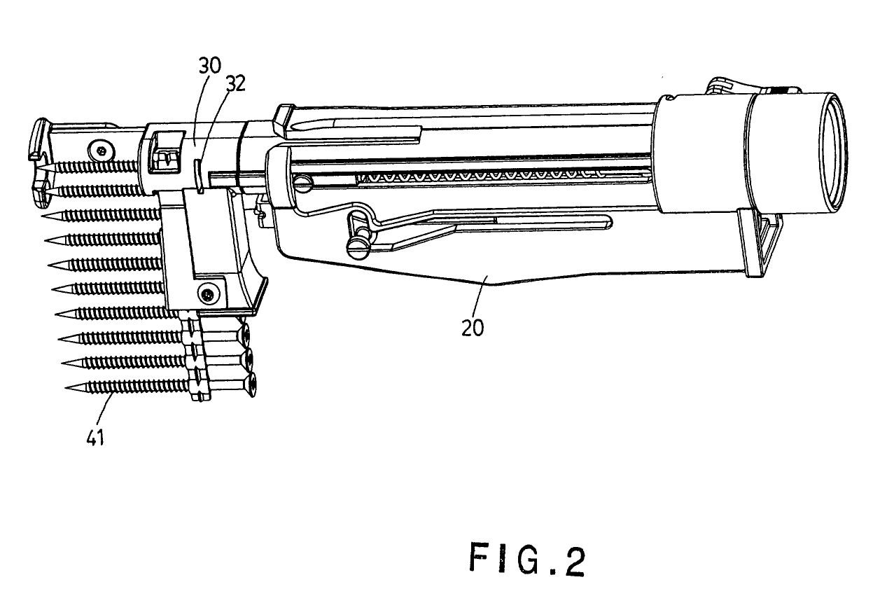

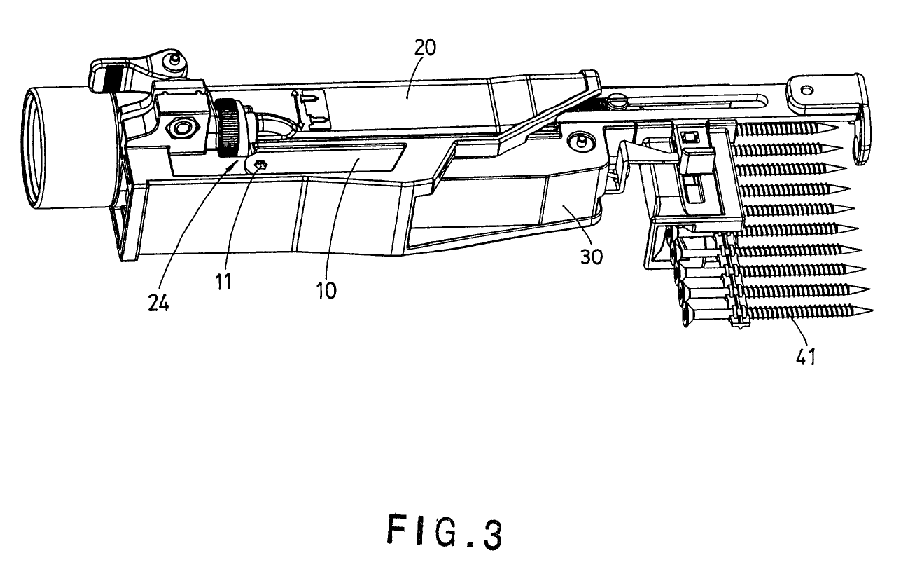

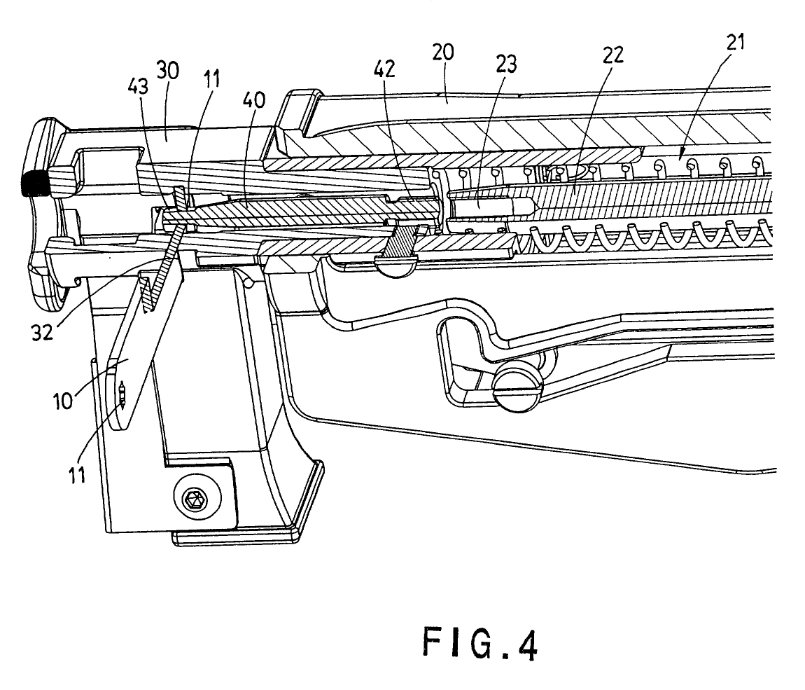

Referring to FIGS. 1 to 4, the screw bit replacing device for a screw dispenser of the present invention comprises a main body 20 having a passage 21 defined therethrough and a shaft 22 is rotatably received in the passage 21. The shaft 22 is connected with a known mechanism so that the shaft 22 can be rotated by operating the mechanism. The shaft 22 has a threaded recess 23 defined in an end thereof. A screw bit 40 has a function end 43 such as a Phillips head, and a threaded end 42 which is engaged with the threaded recess 23 of the shaft 22. The main body 20 has a concavity 24 defined in an outside thereof as shown in FIG. 3 and a plate 10 is engaged with the concavity 24. The plate 10 can be removed from the concavity 24 of the main body 20 and has two apertures 11 defined through two ends thereof. Each aperture 11 has a special shape that fits the function end 43 of the screw bit 40.

A barrel 30 has a tubular portion which is inserted in the passage 21 and series of screws 41 are fed into the barrel 30. A slot 32 is defined through a wall of the tubular portion of the barrel 30. When the shaft 22 is rotated, the screw bit 40 is rotated to engage the screws 41 into objects.

When replacing the screw bit 40, the plate 10 is removed from the concavity 24 and inserted in the slot 32. The aperture 11 of the plate 10 is engaged with the function end 43 of the screw bit 40. The shaft 22 is then rotated by operating the known mechanism such that the screw bit 40 can be easily disengaged from the shaft 22 without disengaging many parts. Similarly, when connecting a new screw bit 40 to the shaft 22, the screw bit 40 is held by the plate 10 and the shaft 22 is then rotated so that the threaded end 42 is easily engaged with the threaded recess 23 of the shaft 22.

While we have shown and described the embodiment in accordance with the present invention, it should be clear to those skilled in the art that further embodiments may be made without departing from the scope of the present invention.

What is claimed is:

1. A screw bit replacing device for screw dispensers, comprising:
a main body having a passage defined therethrough and a shaft rotatably received in the passage, the shaft having a threaded recess defined in an end thereof, a screw bit having a function end and a threaded end which is engaged with the threaded recess of the shaft, a plate removably connected to the main body and having at least one aperture defined therethrough, and
a barrel having a tubular portion inserted in the passage and adapted to be connected to series of screws, a slot defined through a wall of the tubular portion of the barrel, the plate inserted in the slot and the aperture of the plate engaged with the function end of the screw bit.

2. The device as claimed in claim 1, wherein the main body has a concavity defined in an outside thereof and the plate is engaged with the concavity.
